(19) United States
(12) Patent Application Publication
(10) Pub. No.: US 2009/0061935 A1
(43) Pub. Date: Mar. 5, 2009

(54) Interface device of mobile communication terminal using external memory socket and interface method in mobile communication terminal using the same

(75) Inventors: Min Hyoung Lee, Anyang-si (KR); Sang Moon Ban, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/220,884

(22) Filed: Jul. 29, 2008

(30) Foreign Application Priority Data
Sep. 3, 2007 (KR) 2007-0088932

(51) Int. Cl. H04M 1/00

(52) U.S. Cl. 455/558

(57) ABSTRACT

An interface device of a mobile communication terminal that enables both universal serial bus (USB) communication and charging functions using an external memory socket, and an interface method in a mobile communication terminal using the interface device are disclosed. The interface device includes: a socket module into which a card is inserted; and an interface control unit determining whether the card inserted into the socket module is an external memory card or a universal serial bus (USB) communication card connected to a USB connection line connecting the mobile communication terminal to a personal computer (PC), and performing a function corresponding to the type of the card.

### CROSS-REFERENCE TO RELATED APPLICATION(S) AND CLAIM OF PRIORITY

The present application claims priority to an application entitled “INTERFACE DEVICE OF MOBILE COMMUNICATION TERMINAL USING EXTERNAL MEMORY SOCKET AND INTERFACE METHOD IN MOBILE COMMUNICATION TERMINAL USING THE SAME” filed in the Korean Intellectual Property Office on Sep. 3, 2007 and assigned Serial No. 2007-0088932, the contents of which are incorporated herein by reference.

### TECHNICAL FIELD OF THE INVENTION

The present invention relates generally to an interface technology using an external memory socket and, more particularly, to an interface device of a mobile communication terminal that enables both universal serial bus (USB) communication and charging functions using an external memory socket, and an interface method in a mobile communication terminal using the same.

### BACKGROUND OF THE INVENTION

In general, a mobile communication terminal refers to terminals, such as a personal mobile communication terminal (PMCT), a personal digital assistant (PDA) terminal, a smart phone, an international mobile telecommunication (IMT)-2000 terminal, and a wireless local area network (LAN) terminal, that can realize various functions, such as a wireless communication function, using application programs, during carrying thereof by a personal user.

Recently, a mobile communication terminal basically includes a socket into which an external memory card such as a secure digital (SD) card is inserted, and a USB connector for communication with a personal computer (PC) and charging thereof additionally.

However, a conventional mobile communication terminal has a difficulty in being miniaturized and lightened due to the existence of an external memory socket and a USB connector. Furthermore, due to the large number of insert ports in a mobile communication terminal, it is difficult for a user to find out locations of the insert ports.

### SUMMARY OF THE INVENTION

To address the above-discussed deficiencies of the prior art, it is a primary object to provide an interface device of a mobile communication terminal that enables both communication of USB communication with a PC and charging of its battery using an external memory socket into which an external memory card may be inserted, and an interface method of a mobile communication terminal using the same.

In accordance with an exemplary embodiment of the present invention, there is provided an interface device of a mobile communication terminal using an external memory socket, the interface device including: a socket module into which a card is inserted; and an interface control unit checking whether the card inserted into the socket module is an external memory card or a universal serial bus (USB) communication card connected to a USB connection line connecting the mobile communication terminal to a personal computer (PC), and activating and performing a function corresponding to the type of the card.

In accordance with another exemplary embodiment of the present invention, there is provided an interface method in a mobile communication terminal including: inserting a card in the form of an external memory card into a socket module; checking whether the card inserted into the socket is an external memory card or a USB communication card connected to a USB connection line connecting the mobile communication terminal to a PC; and activating a function corresponding to the type of the card.

As mentioned above, an interface device of a mobile communication terminal and an interface method in a mobile communication terminal using the same according to embodiments of the present invention enable USB communication and charging functions together just using an external memory socket. Therefore, the size of a mobile communication terminal may be miniaturized. Furthermore, convenience for a user may increase due to one socket having various functions.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram schematically illustrating an interface device of a mobile communication terminal according to an embodiment of the present invention;

FIG. 2 is a view schematically illustrating an accessory detector according to the embodiment of the present invention;

FIG. 3 is a view illustrating a control table according to the embodiment of the present invention;

FIG. 4 is a flow chart schematically illustrating an interface method of a mobile communication terminal according to an embodiment of the present invention;

FIG. 5 is a view schematically illustrating a charging card according to an embodiment of the present invention; and

FIG. 6 is a view illustrating general allocation of pins in an SD card.

### DETAILED DESCRIPTION OF THE INVENTION

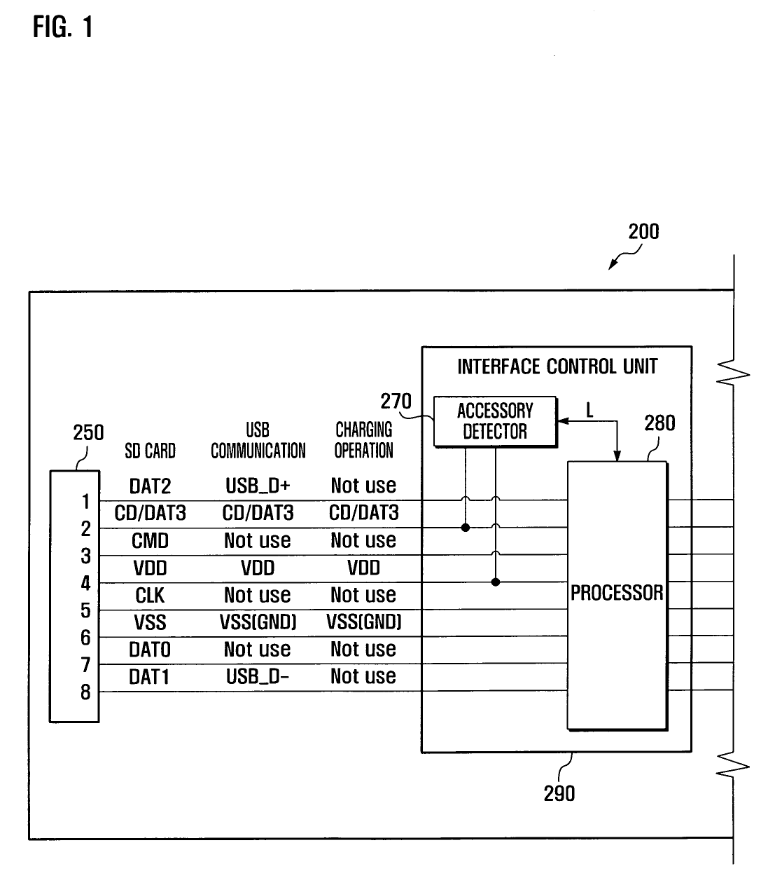

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication terminal.

Detailed descriptions of well-known functions and structures incorporated herein may be omitted to avoid obscuring the subject matter of the present invention.

Likewise, some parts may be magnified, omitted, or schematically illustrated in the accompanying drawings, and the sizes of the parts do not entirely reflect on the actual sizes.

In the exemplary embodiments of the present invention, a micro secure digital (SD) card (T-Flash card), that is a type of SD card, is used as an example of an external memory card. Accordingly, in the exemplary embodiments of the present invention, an SD card basically refers to ‘a micro SD card’, but is not limited thereto. That is, any external memory card having the same type as that of the SD card, such as a general SD card, a mini SD card, and a multimedia card (MMC), may be used.

In the exemplary embodiments of the present invention, an accessory refers to all types of cards and devices that may be inserted into an external memory socket. That is, an accessory commonly refers to an external memory card, a universal serial bus (USB) communication card, and a charging card.

In the exemplary embodiments of the present invention, an interface device that is an element of a mobile communication terminal refers to a device performing an interface between accessories inserted into a socket described later and a control unit of the mobile communication terminal. In the exemplary embodiments of the present invention, for convenience' sake, the description of other elements of the mobile communication terminal, such as a control unit and a storage unit, will be omitted.

FIG. 1 is a block diagram schematically illustrating an interface device of a mobile communication terminal according to an embodiment of the present invention.

Referring to FIG. 1, the interface device 200 includes a socket module 250 and an interface control unit 290.

An SD card or a card having the same external shape as that of the SD card is inserted into the socket module 250. In the embodiment of the present invention, a micro SD card is used as an example of a card inserted into the socket module 250, and the socket module 250 has a structure suitable for the specification of the micro SD card.

Various cards having the same external shape as that of the SD card, as well as the SD card, may be inserted into the socket module 250. More particularly, a USB communication card and a charging card may be inserted into the socket module 250, in which case the USB communication card enables a personal computer (PC) and a mobile communication terminal connected to each other to perform mutual communication and the charging card supplies a charging current to the mobile communication terminal. The USB communication card and the charging card have the same external shape as that of the SD card that is a type of an external memory card. Accordingly, they may be easily inserted and mounted into the socket module 250.

The interface control unit 290 checks whether the card inserted into the socket module 250 is an SD card, a USB communication card connecting the mobile communication terminal to the PC, or a charging card, and activates and performs corresponding functions corresponding to the type of the card.

To achieve this, the interface control unit 290 according to the embodiment of the present invention includes an accessory detector 270 and a processor 280.

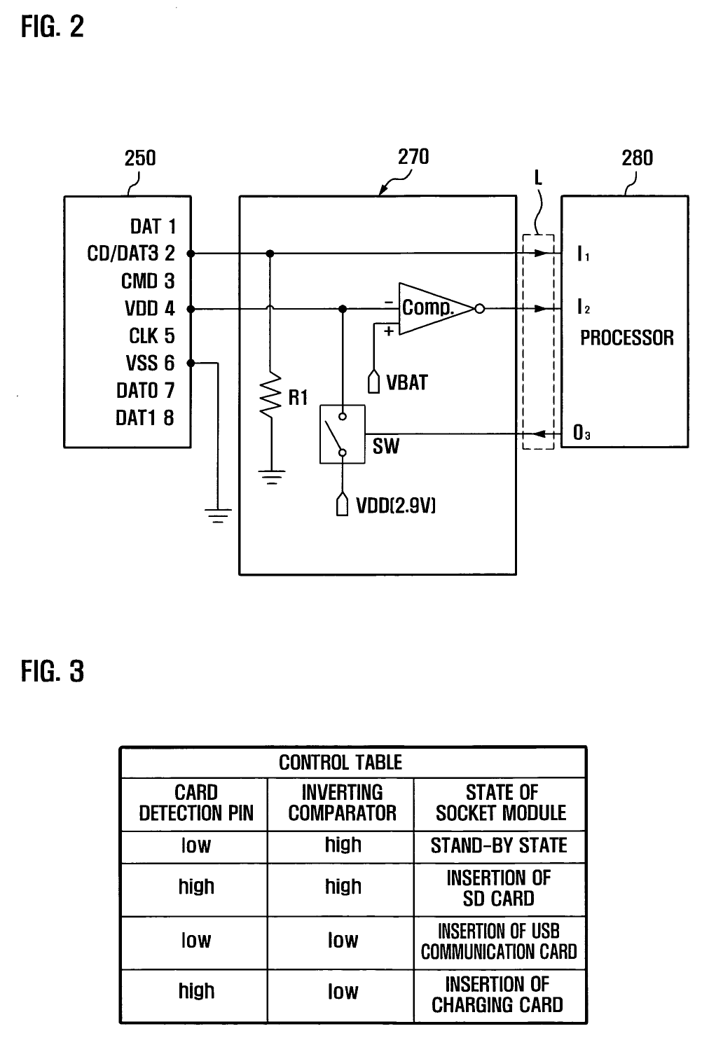

FIG. 2 is a view schematically illustrating an accessory detector according to the embodiment of the present invention. Referring to FIGS. 1 and 2, the accessory detector 270 determines insertion of the card into the socket, and outputs a signal corresponding to the type of the inserted card to the processor 280. To achieve this, the accessory detector 270 includes an inverting comparator Comp, a power supply switch SW, and a first resistor R1.

The inverting comparator Comp has a non-inverting terminal (+) to which a battery power source VBAT of the mobile communication terminal is applied and an inverting (−) terminal connected to the fourth pin VDD of the card. FIG. 6 is a view illustrating general allocation of pins of an SD card. Referring to FIG. 6, the accessory detector 270 uses the second pin CD/DAT3, i.e. a card detection pin and the fourth pin VDD, i.e. a power supply pin of a micro SD card inserted into the socket module 250.

The power supply pin VDD is used to supply power, for example, of approximately 2.9 V to the SD card inserted into the socket module 250. Moreover, upon insertion of the USB communication card or the charging card, the power supply pin VDD may be used to receive power, for example, of approximately 5 V from the PC.

The card detection pin CD/DAT3 is used to check the type of the card inserted into socket module 250.

Meanwhile, the second pin (card detection pin) CD/DAT3 and the fourth pin (power supply pin) VDD are set in correspondence to the micro SD card according to the embodiment of the present invention. In the case of other types of cards, pins suitable for the types of the cards may be selected and used. For example, in the case of a general SD card (not shown), the second pin CD/DAT3 and the fourth pin VDD may be used.

When the voltage output from the power supply pin is greater than the power voltage VBAT applied to the non-inverting terminal (+) of the inverting comparator Comp, the inverting comparator Comp outputs a low signal of ‘0’. On the other hand, when the voltage output from the power supply pin is lower than the power voltage VBAT, the inverting comparator Comp outputs a high signal of ‘1’. In general, the power applied to the non-inverting terminal (+) is the power supplied from a battery of a mobile communication terminal, and has a voltage of approximately 3.4 V to 4.2 V. Accordingly, when the voltage of the inverting terminal (−) is less than or equal to 3.4 V, the inverting comparator Comp outputs a high signal. When the voltage of the inverting (−) terminal is greater than 3.4V, and, for example, is 5V, the inverting comparator Comp outputs a low signal.

The power supply switch SW supplies a specific voltage VDD, for example, of approximately 2.9V, to the power supply pin. When the mobile communication terminal is in a stand-by state, the power supply switch SW according to the embodiment of the present invention basically supplies power to the power supply pin, and, only upon insertion of cards other than the SD card into the socket module 250, the processor 280 interrupts the power to the power supply pin under the control of the processor 280.

One end of the first resistor R1 is connected to the card detection pin, and the other end thereof is connected to a ground voltage. The first resistor R1 is used to determine insertion of a charging card into socket module 250.

The processor 280 communicates with the accessory detector 270 through a signal line L, checks the type of the card inserted into the socket module 250, and performs a function corresponding to the type of the card. The processor 280 controls the power supply switch SW through an output port O₃, and receives a signal output from the inverting comparator Comp and a signal output from the card detection pin, from the accessory detector 270 through input ports I₁ and I₂. The processor 280 checks the type of a card currently inserted into the socket module 250 using a combination of signals received through the input ports I₁ and I₂. In this procedure, the processor 280 checks the type of the card based on a control table shown in FIG. 3.

FIG. 3 is a view illustrating a control table according to an embodiment of the present invention. Referring to FIG. 3, when an output of the inverting comparator Comp is a high signal of ‘1’ and an output of the card detection pin CD/DAT3 is a low signal of ‘0’, the processor 280 determines that the current state is a stand-by state in which no card is inserted into socket module 250. When the output of inverting comparator Comp and the output of card detection pin CD/DAT3 both are a high signal of ‘1’, the processor 280 determines that an SD card is inserted into socket module 250. When it is determined that the card inserted into the socket module 250 is an SD card, the processor 280 provides all signals from respective pins of the SD card to an external memory card interface (not shown).

When the output of the inverting comparator Comp is a low signal of ‘0’ and the output of card detection pin CD/DAT3 is a high signal of ‘1’, the processor 280 determines that a charging card is inserted into socket module 250. In this case, the processor 280 connects the power supply pin and a ground pin (sixth pin VSS) to a battery (not shown) of the mobile communication terminal to charge the battery.

When the output of inverting comparator Comp and the output of card detection pin CD/DAT3 both are a low signal, the processor 280 determines that a USB communication card is inserted into socket module 250. In this case, the processor 280 provides all signals from respective pins of USB communication card to a USB communication interface (not shown). Accordingly, the mobile communication terminal receives power of approximately 5 V from the PC through the power supply pin and the ground pin, and exchanges data with the PC using other data input/output pins. In the embodiment of the present invention, a first pin DAT2 and an eighth pin DAT1 are used to input and output data during USB communication. That is, the first pin DAT2 is used as a USB_D+ terminal and the eighth pin DAT1 is used as a USB_D− terminal. However, the present invention is not limited thereto, and when a different type of card is used, pins suitable for the type of the card may be selected and used. For example, when a general SD card (not shown) is used, the eighth pin DAT1 and the ninth pin DAT2 may be used for the SD card.

Hereinafter, an interface method of a mobile communication terminal according to an embodiment of the present invention will be described in detail. The arrangement of the interface device 200 will become apparent from the following description of the interface method of a mobile communication terminal.

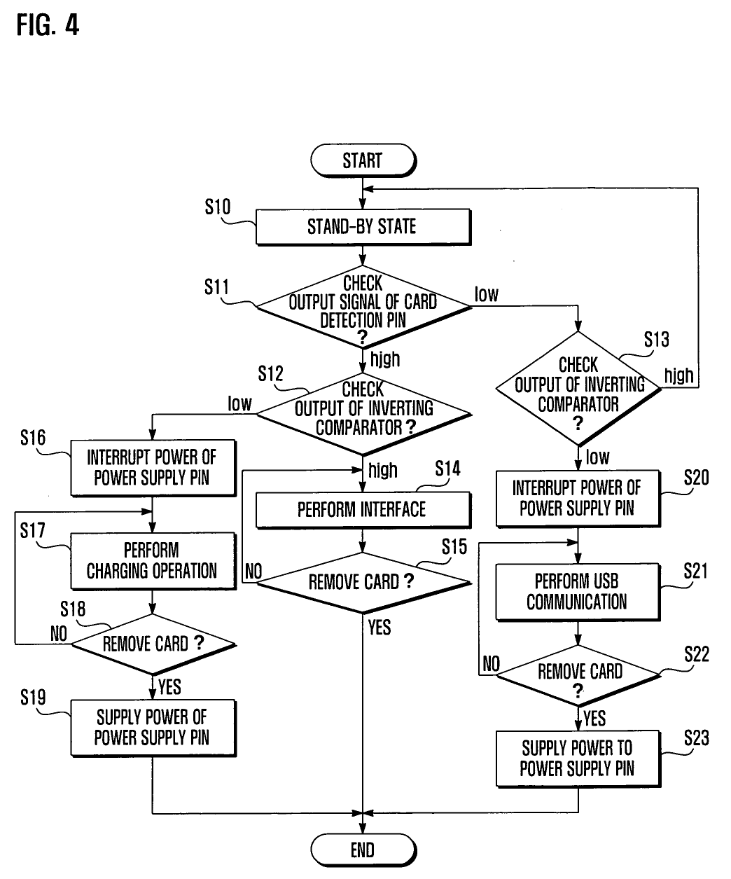

FIG. 4 is a flowchart schematically illustrating an interface method of a mobile communication terminal according to an embodiment of the present invention.

Hereinafter, an interface method of a mobile communication terminal according to the embodiment of the present invention will be described with reference to FIGS. 1 to 4.

In the description of the embodiment of the present invention, the term “a stand-by state” refers to a state in which a socket module 250 is unoccupied, that is, no card is inserted into the socket module.

In the step S10, the socket module 250 is in a stand-by state. A processor 280 closes a power supply switch SW to supply power VDD of approximately 2.9 V to the fourth pin of a socket module 250, that is, a power supply pin. In the interface device 200 according to the embodiment of the present invention, when the socket module 250 is in a stand-by state, the power supply switch SW is always closed, in which case the power VDD of approximately 2.9V is supplied to the power supply pin at any time. Then, the same magnitude of power VSS of approximately 2.9 V is applied to an inverting terminal (−) of an inverting comparator Comp connected to the power supply pin. However, a voltage VBAT of approximately 3.4 V to 4.2 V that is greater than the power VDD is applied to a non-inverting terminal (+) of the inverting comparator Comp. As a result, the inverting comparator Comp continues to output a high signal in the stand-by state.

No card is inserted into the socket module 250 of the mobile communication terminal, in which case a low signal is output from the second pin (i.e., the card detection pin).

Accordingly, a high signal output from the inverting comparator Comp and a low signal output from the card detection pin are input to the processor 280. As a result, the processor 280 determines that the socket module 250 is in a stand-by state in which no card is inserted into the socket module 250, from the control table shown in FIG. 3.

When a user inserts a card into the socket module 250 of the mobile communication terminal in the stand-by state, the interface control unit 290 checks the type of the card inserted into the socket module 250.

First, the case of insertion of an SD card into the socket module will be described in detail.

When a user inserts a card into the socket module 250, an output signal of the card detection pin is checked in the step S11. Upon insertion of an SD card, the card detection pin that has output a low signal in a standby state starts to output a high signal. This is why the SD card supplies the power VDD of approximately 2.9 V received through the card detection pin to the interface device 200 again. Accordingly, the power VDD of approximately 2.9 V is applied to the card detection pin, in which case the processor 280 determines that a high signal is input from the card detection pin.

When a high signal is input to processor 280 from the card detection pin, the processor 280 checks an output of inverting comparator Comp in the step S12.

When the inserted card is an SD card, the inverting comparator Comp continues to output a high signal without change in the output thereof. As described above, the inverting comparator Comp and the card detection pin both output a high signal, in which case the processor 280 determines that an SD card is currently inserted into the socket module 250.

Accordingly, the processor 280 provides signals transmitted from the socket module 250 to an external memory interface (not shown) in the step S14. In this case, the external memory interface may be located inside the processor 280, or may be separately installed. The external memory interface may have the same structure as that of a conventional external memory interface. A technology for use of an SD card in a mobile communication terminal through an external memory interface is well known in the art, in which case the description of the external memory interface will be omitted.

Then, in the step S15, when a user removes the SD card from the socket module 250 after using the SD card, the card detection pin outputs a low signal again. Accordingly, a high signal and a lower signal are input from the inverting comparator Comp and the card detection pin to the processor 280 respectively, in which case the processor 280 determines that the SD card is removed from the socket module 250.

Next, the case of insertion of a USB communication card into the socket module 250 will be described in detail.

Here, the USB communication card will be simply described below. According to the embodiment of the present invention, it is essential that USB communication may be performed through the socket module 250 into which the SD card is inserted. Accordingly, it is necessary for one end of a USB connection line that is inserted into the mobile communication terminal to have the same external shape as that of the SD card, so as to enable USB communication between the mobile communication terminal and a PC. In the embodiment of the present invention, a part having the same external shape as that of an SD card and inserted into the socket module 250 is now referred to as a USB communication card.

First, in the step S11, the processor 280 checks an output signal of the card detection pin. When the USB communication card is inserted by a user, the card detection pin in a stand-by state continues to output a low signal. On the other hand, in the step S13, a high signal from the inverting comparator Comp is converted to a low signal to be outputted. In detail, when the USB communication card is connected to the socket module 250, power of 5V is applied to the fourth pin VDD of the socket module 250 from the PC. Accordingly, power of 5V is also applied to an inverting terminal (−) of the inverting comparator Comp. The power of 5V is greater than a reference voltage VBAT of the inserting terminal (−) that ranges from 3.4 V to 4.2V, in which case the inverting comparator Comp that has output a high signal converts the high signal to a lower signal to output the converted low signal.

Accordingly, the inverting comparator Comp and the card detection pin both output a low signal, in which case the processor 280 determines that the USB communication card is currently inserted into the socket module 250.

In the step S20, the processor 280 controls the power supply switch SW to interrupt power VDD of approximately 2.9 V supplied to the power supply pin. Next, in the step S21, the processor 280 provides signals from other pins of the socket module 250 to a USB communication interface (not shown), thereby achieving USB communication. In this case, the USB communication interface may be located inside the processor 280 or may be separately installed. A technology related to a USB communication interface is well known in the art, in which case the description thereof will be omitted as in the external memory interface.

Meanwhile, in the embodiment of the present invention, as illustrated in FIG. 1, the first pin USB_D+, the fourth pin VDD, the sixth pin GND, and the eighth pin USB_D− are used in USB communication of the mobile communication terminal with the PC. However, the present invention is not limited thereto, and various applications and modifications are possible according to the types of cards.

In the step S22, after completion of USB communication, when a user removes the USB communication card from the socket module 250, the power of 5 V from PC is no longer supplied to the power supply pin. The inverting comparator Comp that has output a low signal outputs a high signal again, and a high signal and a low signal are input to the processor 280 from the inverting comparator Comp and the card detection pin respectively. As a result, the processor 280 determines that the USB communication card has been removed from socket module 250.

Next, the case of insertion of a charging card into the socket module 250 will be described in detail.

The structure of the charging card is similar to that of the above-mentioned USB communication card. In a conventional mobile communication terminal, one end of a charger (not shown) is inserted into a separate charging insertion port to charge the mobile communication terminal. However, a mobile communication terminal according to the embodiment of the present invention is charged using the socket module 250 into which the SD card is inserted. Accordingly, it is necessary for one end of a charger inserted into the mobile communication terminal to have the same external shape as that of the SD card. In the embodiment of the present invention, the part inserted into the socket module 250 and having the same external shape as that of SD card is referred to as ‘a charging card’.

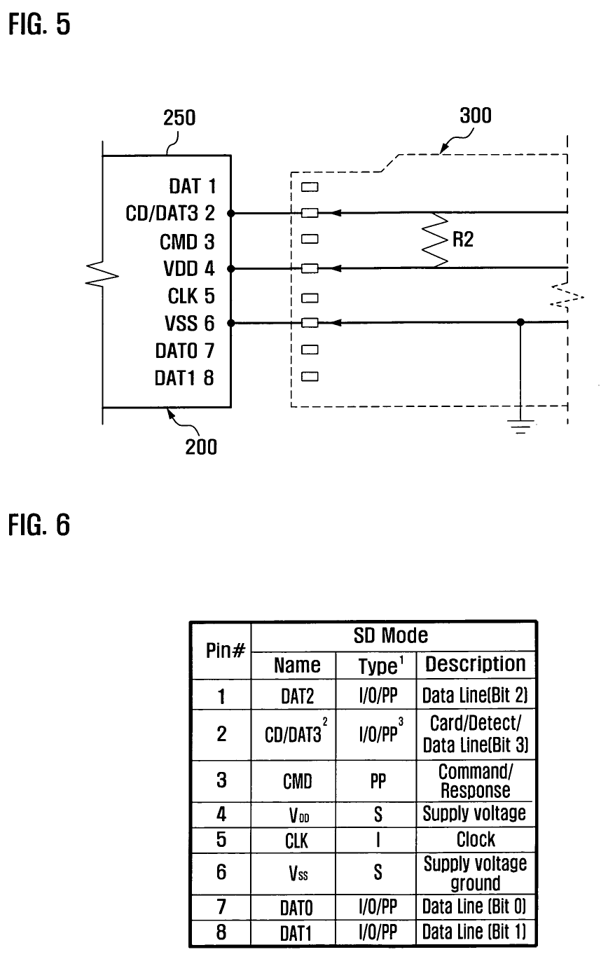

FIG. 5 is a view schematically illustrating a charging card according to an embodiment of the present invention.

Referring to FIG. 5, the charging card 300 according to the embodiment of the present invention is inserted into the socket module 250 using only the second pin CD/DAT3, the fourth pin VDD, and the sixth pin VSS. The charging card 300 supplies power of approximately 5 V to the mobile communication terminal through a power supply pin (the fourth pin) and a ground pin (the sixth pin) of the socket module 250 to the mobile communication terminal to charge a battery of the mobile communication terminal.

The charging card 300 according to the embodiment of the present invention includes a second resistor R2 one end of which is connected to a power supply line connected to the fourth pin and the other end of which is connected to a second pin (i.e., a card detection pin). The second resistor R2 is installed to allow an interface control unit 290 of the mobile communication terminal to determine insertion of the charging card 300. Upon insertion of the charging card 300 into the socket module 250, a voltage dropped by a predetermined magnitude from the voltage of 5 V supplied from the charging card 300 is supplied to the card detection pin. Due to this, a voltage of a magnitude recognizable by the processor 280 as a high signal may be supplied to the processor 280. Accordingly, the first and second resistor R1 and R2 have resistance values suitable for dropping the voltage of the card detection pin to the aforementioned voltage of approximately 2.9 V.

Upon insertion of the charging card 300 into the socket module 250 of the mobile communication terminal, in the step S11, the processor 280 checks the output signal of the card detection pin. As mentioned above, the power (the voltage of which has been dropped) from charging card 300 is applied to the card detection pin, in which case the processor 280 receives a high signal from the card detection pin.

Thereafter, in the step S13, the high signal output from the inverting comparator Comp is converted to a low signal to be outputted. This is because the power of 5V is applied to the fourth pin VDD as in the above-mentioned USB communication card.

As mentioned above, when inverting comparator Comp outputs a low signal and the card detection pin outputs a high signal, the processor 280 determines that the charging card 300 is currently inserted into the socket module 250.

In the step S16, the processor 280 controls the power supply switch SW to interrupt the power VDD that has been supplied from the power supply pin. In the step S17, the power supplied from the fourth pin is supplied to a battery (not shown) of the mobile communication terminal to charge the mobile communication terminal.

Meanwhile, as shown in FIGS. 1 and 5, the charging card 300 according to the embodiment of the present invention uses a second pin CD/DAT3, a fourth pin VDD, and a sixth pin VSS. However, the present invention is not limited thereto, and various pins may be applied or modified according to the types of cards.

Thereafter, in the step S18, when the user removes the charging card 300 from the socket module 250 to complete the charging procedure, the power of 5V supplied from the charger is no longer supplied to the power supply pin. Accordingly, the inverting comparator Comp that has output a low signal outputs a high signal again, whereas the card detection pin that has output a high signal outputs a low signal again. As a result, the processor 280 determines that the charging card 300 has been removed from the socket module 250.

An interface device of a mobile communication terminal using an external memory socket and an interface method in a mobile communication using the same according to the present invention, enable performance of both USB communication and charging functions using the single external memory socket. Accordingly, the size of mobile communication terminal may be minimized. Furthermore, the single external memory socket realizing various functions enhances the convenience for a user.

Meanwhile, an interface device of a mobile communication terminal using an external memory socket and an interface method in a mobile communication terminal using the same according to the present invention are not limited to the above-mentioned embodiments of the present invention and may be variously modified by those skilled in the art without departing from the spirit of the present invention.

For example, in the above-mentioned embodiments of the present invention, an SD card (particularly, a micro SD card) is used as an external memory card. However, the present invention is not limited thereto. That is, various types of external memory cards, such as a compact flash (CF) card, an xD picture card, a memory stick card, or a smart media (SM) card, are applicable.

An interface device of a mobile communication terminal and an interface method in a mobile communication have been described using the embodiments of the present invention. However, the present invention may be applied to any electronic device capable of using an external memory card and performing USB communication.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An interface device of a mobile communication terminal using an external memory socket, the interface device comprising:
a socket module into which a card is inserted; and
an interface control unit determining whether the card inserted into the socket module is an external memory card or a universal serial bus (USB) communication card connected to a USB connection line connecting the mobile communication terminal to a personal computer, and performing a function corresponding to the type of card inserted into the socket module.

2. The interface device of claim 1, wherein the card inserted into the socket module has an external shape of a secure digital (SD) card.

3. The interface device of claim 2, wherein the interface control unit determines the type of the card inserted into the socket module using a power supply pin of the card and a single input/output data pin.

4. The interface device of claim 3, wherein the single input/output pin is a card detection pin.

5. The interface device of claim 4, wherein the interface control unit comprises:
an accessory detector detecting insertion of the card into the socket module, outputting a signal corresponding to the type of the inserted card, and if the inserted card is an external memory card, supplying power to the external memory card; and
a processor determining the type of the card based on the signal output from the accessory detector and performing a function corresponding to the type of the card inserted into the socket module.

6. The interface device of claim 5, wherein the accessory detector comprises an inverting comparator inverting and outputting a detection signal and having a non-inverting terminal to which power is applied from a battery of the mobile communication terminal and an inverting terminal to which the power supply pin of the card is connected.

7. The interface device of claim 6, wherein the accessory detector further comprises a power supply switch supplying power to the power supply pin of the card under the control of the processor.

8. The interface device of claim 7, wherein the accessory detector further comprises a first resistor one end of which is connected to the card detection pin, and the other end of which is grounded.

9. The interface device of claim 6, wherein the processor determines the type of the card based on outputs of the inverting comparator and the card detection pin.

10. The interface device of claim 9, wherein, if the card inserted into the socket module is determined to be a USB communication card, the interface control unit receives power from the personal computer through the power supply pin and the inverting comparator, and exchanges data using data input/output pins other than the card detection pin.

11. The interface device of claim 8, wherein the card further comprises a charging card provided at one end of a charger supplying a charging current to the mobile communication terminal.

12. The interface device of claim 11, wherein the charging card comprises:
a power supply line connected to the power supply pin to supply power; and
a second resistor one end of which is connected to the card detection pin and the other end of which is connected to the power supply line.

13. The interface device of claim 2, wherein the SD card is selected from the group consisting of a mini SD card, a micro SD card, and a multimedia card (MMC).

14. An interface method in a mobile communication terminal comprising:
inserting a card into a socket module;
determining whether the card inserted into the socket module is an external memory card or a universal serial bus (USB) communication card connected to a USB connection line connecting the mobile communication terminal to a personal computer; and
activating a function corresponding to the type of the card inserted into the socket module.

15. The method of claim 14, wherein the card inserted into the socket module has a shape of a secure digital (SD) card.

16. The method of claim 14, wherein determining the type of the card comprises determining the type of the card using a power supply pin and a card detection pin of the card.

17. The method of claim 16, wherein determining the type of the card further comprises, if the card is an external memory card, supplying power to the external memory card.

18. The method of claim 16, wherein determining the type of the card comprises determining the type of the card based on an inverted output signal of an inverting comparator having a non-inverting terminal to which power is applied from a battery of the mobile communication terminal and an inverting terminal to which the power supply pin of the card is connected and an output signal of the card detection pin.

19. The method of claim 9, further comprising, in the card is a USB communication card, receiving power from the personal computer through the power supply pin and the inverting comparator and exchanging data using data input/output pins other than the card detection pin.

20. The method of claim 15, wherein the SD card is selected from the group consisting of a mini SD card, a micro SD card, and a multimedia card (MMC).
